(19) United States
(12) Patent Application Publication
(10) Pub. No.: US 2006/0264205 A1
(43) Pub. Date: Nov. 23, 2006

(54) Systems and methods for call screening on a mobile telecommunications device

(75) Inventor: Benjamin K. Gibbs, Camas, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc.

(21) Appl. No.: 11/132,891

(22) Filed: May 19, 2005

(51) Int. Cl. H04Q 7/20

(52) U.S. Cl. 455/413; 455/416; 455/415

(57) ABSTRACT

A mobile telecommunications device configured for use in a wireless communication system is disclosed that includes a processor and memory in electronic communication with the processor. Instructions are stored in the memory. The instructions are executable to implement a method for call screening. An incoming call is received from a caller. The incoming call is answered and put on hold. Voicemail is dialed into such that the voicemail call does not automatically go into the voicemail retrieval menu. The incoming call and the voicemail call are joined into a three-way conference call such that a user of the mobile telecommunications device is able to screen the incoming call.

### TECHNICAL FIELD

The present invention relates generally to mobile telecommunications devices. More specifically, the present invention relates to systems and methods for call screening on a mobile telecommunications device.

### BACKGROUND

The advent of the telephone answering machine introduced the public to the useful practice of call screening. Several tools have been developed to assist a user with call screening. These include: the answering machine, Call Waiting, Caller ID, voicemail and various combinations of these. To screen a call, a user waits for an answering machine to take an incoming call and then listens to the caller record a message. When the answering machine takes a message the user is given important information that can be used to decide whether to take the call. The user can determine the caller's identity either by their voice or by their message. The user can also determine the purpose of the call. After discovering either the caller's identity or their purpose, the user can choose to take the call. If the user decides to take the call, they can speak with the caller by picking up the telephone. If the user did not wish to speak with the caller, the answering machine could simply finish recording the message and the caller would hang up.

The ability to choose whether to answer a call without the caller knowing that the user is currently listening has many advantages. For example, call screening allows the user to continue with what they were doing before the call without interruption. The user can also avoid wasting time chatting but enables them to obtain any information from the call that may be important to them. Screening calls also gives the user the ability to simply ignore the caller altogether.

The answering machine has the ability to screen calls in real time while storing all messages in a central location. However, the problem with telephone answering machines is that if a user is already on the telephone, the caller receives a busy signal and is not able to leave a message.

Call Waiting addressed the problem with busy signals. Call Waiting notifies a user when another caller is trying to reach the user by a special tone. The user can then switch between the active call and the new call keeping the original caller on hold. The problem with Call Waiting is that the user could not identify the new caller without actually taking the call. A user could implement both the answering machine and Call Waiting, but is still forced to either take a call from a caller on Call Waiting or to hope that the caller would try later so that the user could screen the call.

The solution to the problem of busy signals and taking unidentified calls on Call Waiting came in the form of voice mail. Voice mail allows a user to be on a call while a second incoming call is routed to a remote voice mail system. Voice messaging also prevents lost calls by eventually routing all calls, either after a certain number of rings or if the line was busy, to a remote voice mail system. However, because the voice mail system is at a remote location, the user is not able to screen for the caller's identity or purpose by listening to the message in real time.

Caller ID is another method of screening calls. A user with Caller ID can identify a caller by a box near the telephone that displays the caller's name and telephone number. This allows the user to screen calls based on identity but not purpose. Additionally, Caller ID boxes are generally small and a user has to go to the telephone to read the display. If there were only one Caller ID box at the user's location, then only that telephone could be used to screen calls. In contrast, the user of an answering machine can identify both the caller and the caller's purpose from anywhere in the room in real time. Additional boxes could be installed, but this adds cost while still requiring the user to stop what they are doing to go and check the display. Another problem with Caller ID is that some callers have their numbers blocked so that a user without an answering machine or voicemail is forced to take the call to determine the caller's identity.

A combination of voicemail, Call Waiting, and Caller ID can also be used to solve some of these problems. Because Caller ID developed the ability to identify the caller on Call Waiting, this combination became more effective. A user can talk to a caller and, upon receiving a second call, identify the new caller using Caller ID, and choose to let the call go to voicemail by not switching lines. However, if the second caller has a blocked number, the user still has to take the call or check the message later to determine the caller's identity. Furthermore, the development of wireless handsets required the user to be near the telephone base to check the Caller ID.

Cellular telephone technology allows users great mobility while being able to take and make calls. Mobile phone users face similar challenges to screening their calls as landline users. Mobile telephones typically use a remote voicemail system. The user can access their messages by calling into the remote voicemail system and using a menu to choose which messages to listen to, save, or delete. This gives users the advantage of not missing calls because callers can leave a message for the user even if the user is on the phone. The remote voicemail system has an advantage for remote users of identifying a user by their telephone number, similar to Caller ID on a landline rather than requiring an access code. However, as with the landline remote voicemail service, the user could not screen the call in real time.

One solution to this problem is to return to the answering machine. For the mobile phone, this meant that the call was answered locally instead of forwarding to the remote voicemail system. This allows the user to screen calls by recording the caller's message while listening to the call over the phone's loudspeaker.

This approach has many problems. If a user screens a call, the locally recorded voice messages are now split between those stored on the handset and those stored on the remote voicemail system. This sacrifices the convenience of storing all messages in a central location and sacrifices needed space on the mobile phone. Additionally, the phone may use extra power because it has to record the message locally while the user screens the call.

An additional drawback is that the user has to record a greeting for both the remote voicemail system and the local system. This means that callers could identify differences between the local greeting and the remote voicemail system greeting and deduce that one is being used for call screening effectively telling the caller that the user is screening their call.

Unfortunately, known systems and methods for call screening suffer from various drawbacks. Accordingly, benefits may be realized by improved systems and methods for call screening. Some exemplary systems and methods for call screening on mobile telephones are described herein.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram illustrating an embodiment of a system for call screening;

FIG. 2 is a conceptual block diagram of an embodiment of a system for call screening;

FIG. 3 is a flow diagram illustrating a general method for call screening;

FIG. 4 is a functional block diagram of an embodiment of a mobile telecommunications device;

FIG. 5 is an illustration of one embodiment of a mobile telecommunications device;

FIG. 6 is a flow diagram illustrating the handling of an incoming call;

FIG. 7 is a flow diagram of an embodiment of a method to answer the call that is being screened midway through the message recording;

FIG. 8 is a flow diagram illustrating an embodiment of a method for the recipient to ignore the caller midway through the message recording; and

FIG. 9 is a flow diagram illustrating the completion of the call.

### DETAILED DESCRIPTION

A mobile telecommunications device configured for use in a wireless communication system is disclosed that includes a processor and memory in electronic communication with the processor. Instructions are stored in the memory. The instructions are executable to implement a method for call screening. An incoming call is received from a caller. The incoming call is answered and put on hold. Voicemail is dialed into such that the voicemail call does not automatically go into the voicemail retrieval menu. The incoming call and the voicemail call are joined into a three-way conference call such that a user of the mobile telecommunications device is able to screen the incoming call. Certain embodiments may receive user input indicating that the incoming call is to be screened.

In some embodiments of the mobile telecommunications device, dialing into voicemail such that the voicemail call does not automatically go into the voicemail retrieval menu may include dialing a voicemail number anonymously. In addition, it may include dialing a special voicemail number so as to avoid the voicemail retrieval menu. The special voicemail number may be configured to identify caller line ID of the mobile telecommunications device's voicemail call but not go into the voicemail retrieval menu.

Dialing into voicemail such that the voicemail call does not automatically go into the voicemail retrieval menu may also include sending a code or password to the voicemail to indicate that a message should be left for the mobile telecommunications device's mailbox number.

The mobile telecommunications device may activate a speaker and mute a microphone when performing call screening.

The device may also receive user input indicating that the user wishes to answer the incoming call that is being screened. The device may then drop the voicemail call so that only a two-party call is active. A microphone may be enabled on the mobile telecommunications device.

The mobile telecommunications device may receive user input indicating that the user wishes to silence the incoming call that is being screened. The device may silence a speaker on the mobile telecommunications device.

In a further embodiment of the mobile telecommunications device user input may be received indicating that the user wishes to silence the incoming call that is being screened. The device may then drop the user so that only a two-party call is active and is the incoming call to the voicemail.

In another embodiment the mobile telecommunications device may receive user input comprising an attempt by the user to use the mobile telecommunications device. A warning may be presented to the user that indicates call screening is still in progress.

A method for call screening is also disclosed for a mobile telecommunications device. An incoming call is received from a caller. The incoming call is answered and put on hold. Voicemail is dialed into such that the voicemail call does not automatically go into the voicemail retrieval menu. The incoming call and the voicemail call are joined into a three-way conference call such that a user of the mobile telecommunications device is able to screen the incoming call.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

Call screening is a popular function on home answering machines. A caller's voice can be heard during the recording of a message and the recipient can decide if they wish to answer the call or allow the message recording to continue. For mobile phones, this situation is not as easy to accomplish as the simple home answering machine. Typically with cellular telephones, calls have to be forwarded to a voicemail system that records the message. This does not enable the call to be screened. One current solution to this is for the mobile phone to answer the call locally instead of forwarding to the operator's voicemail system. The mobile phone then plays a local voicemail prompt, records the caller's message and plays the call over the phone's loudspeaker so it can be screened. There are many problems with this approach. For example, voice messages are now split between those stored on the handset and those stored on the operator's voicemail system. Furthermore, callers may identify differences between the handset's voicemail prompt and the operator's voicemail system prompt and deduce that one is being used for call screening. This could defeat one of the benefits of call screening: the artifice that the recipient is not screening the call. Additional problems include the fact that storing messages on the handset takes up memory on the handset that could be used for other things or that could be a limited resource. Finally, the phone has to be able to record at the same time as performing the call function, which may need additional processing power

One solution proposed for Plain Old Telephone Systems (POTS) that enables call screening with a voicemail system is to utilize 3-way conference calling. The caller either calls the recipient's voicemail number or the phone itself and through one mechanism or another a 3-way call is set up with the recipient's phone just listening, i.e., on mute. If during the recording phase the recipient wishes to break into the conversation he or she can do so by taking the phone off-hook. The 3-way call is then dropped to just a 2-way call between the caller and the recipient. Various other systems implement this concept. However, what these other systems do not address is a specific issue with current voicemail systems for cellular telephones. The specific issue arises when the voicemail system (like that used by T-Mobile in the U.S.) identifies callers using Caller Line ID. This means that if the recipient's handset tries to establish the 3-way call, instead of allowing messages to be recorded, the voicemail system will automatically put the caller into a voicemail retrieval menu state for controlling their mailbox. Normally this is a benefit for the user when they call voicemail because they do not need to identify themselves to the system. However, automatically putting the caller into a voicemail retrieval menu state is not the desired operation for call screening. The systems and methods herein overcome this problem.

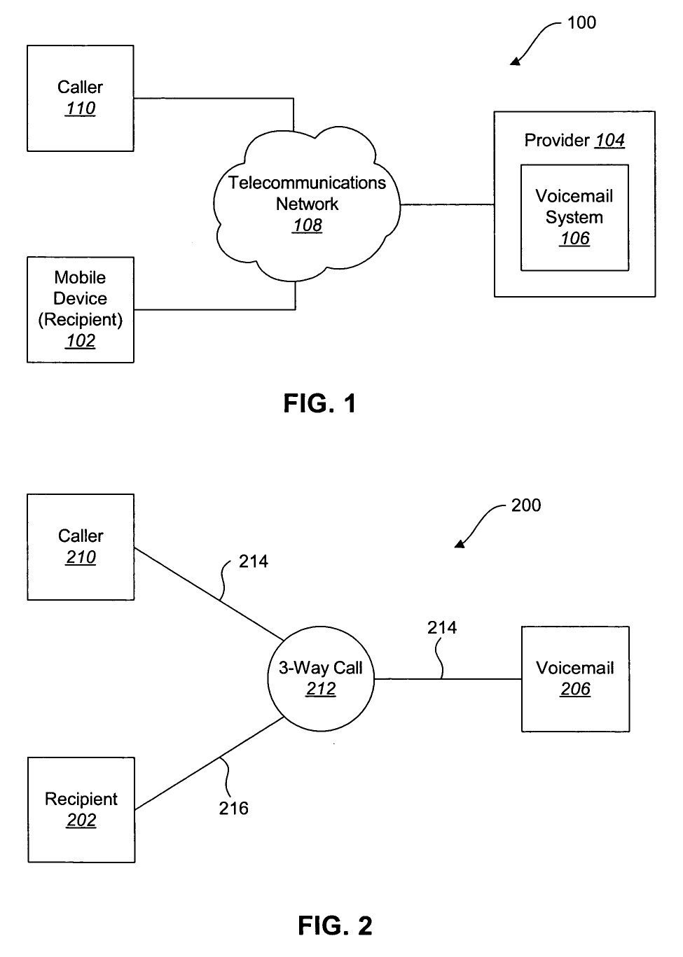

FIG. 1 is a block diagram of an embodiment 100 of a system for call screening. In the system 100 a wireless mobile phone 102, mobile device 102 or handset 102 operates on a provider's system 104 that has voicemail 106 as one of its services. The mobile device 102 is used in combination with a telecommunications network 108 so that one or more callers 110 may call the recipient at the mobile device 102 through the telecommunications network 108.

FIG. 2 is a conceptual block diagram of an embodiment 200 of the system for call screening. Generally, as is shown in FIG. 2, the recipient's mobile device 202 may be used to enter into a three-way conference call 212 in order to enable the recipient 202 to efficiently screen the incoming call from the caller 210. While the caller 210 is leaving a voicemail, indicated by the voicemail connection 214, the recipient is able to screen the call, indicated by the screening connection 216.

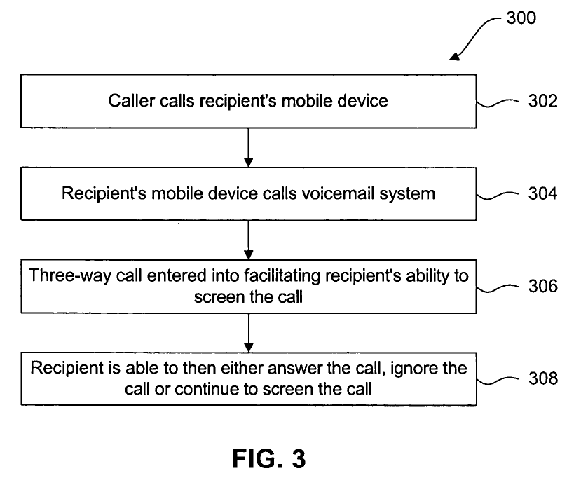

FIG. 3 is a flow diagram illustrating a general method 300 for efficient and audible call screening. This method 300 and various embodiments thereof will be more fully described throughout this detailed description. FIG. 3 is a general overview of an embodiment of the methods described herein. The caller calls 302 the recipient's mobile device 102. The recipient's mobile device calls 304 into its voicemail system 106. A three-way call is entered into 306 facilitating the recipient's ability to screen the call. The recipient 102 is then able to answer 308 the call, ignore the call or continue to screen the call.

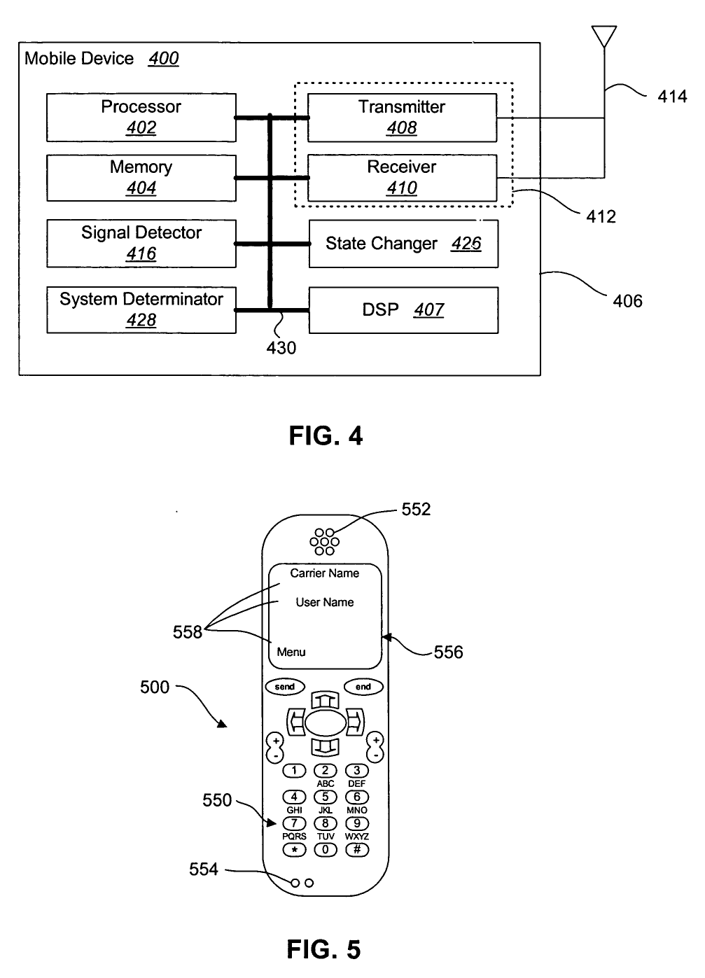

The mobile device, in one embodiment, is a cellular telephone. An embodiment of a mobile device 400 is illustrated in the functional block diagram of FIG. 4. The system 400 includes a processor 402 that controls operation of the system 400. The processor 402 may also be referred to as a CPU. Memory 404, which may include both read-only memory (ROM) and random access memory (RAM), provides instructions and data to the processor 402. A portion of the memory 404 may also include non-volatile random access memory (NVRAM).

The system 400 also includes a housing 406 that contains a transmitter 408 and a receiver 410 to allow transmission and reception of data, such as audio communications, between the system 400 and a remote location, such as a cell site controller or base station. The transmitter 408 and receiver 410 may be combined into a transceiver 412. An antenna 414 is attached to the housing 406 and electrically coupled to the transceiver 412. Additional antennas (not shown) may also be used. The operation of the transmitter 408, receiver 410 and antenna 414 is well known in the art and need not be described herein.

The system 400 also includes a signal detector 416 used to detect and quantify the level of signals received by the transceiver 412. The signal detector 416 detects such signals as total energy, pilot energy per pseudonoise (PN) chips, power spectral density, and other signals, as is known in the art.

A state changer 426 of the system 400 controls the state of the wireless communication device based on a current state and additional signals received by the transceiver 412 and detected by the signal detector 416. The system 400 also includes a system determinator 428 used to control the wireless communication device and determine which service provider system the wireless communication device should transfer to when it determines the current service provider system is inadequate.

The various components of the system 400 are coupled together by a bus system 430 which may include a power bus, a control signal bus, and a status signal bus in addition to a data bus. However, for the sake of clarity, the various busses are illustrated in FIG. 4 as the bus system 430. The system 400 may also include a digital signal processor (DSP) 407 for use in processing signals. One skilled in the art will appreciate that the system 400 illustrated in FIG. 4 is a functional block diagram rather than a listing of specific components.

The methods disclosed herein may be implemented in an embodiment of a mobile device 400. In one embodiment, the methods described herein may be implemented through executable instructions stored in the memory 404 and executed by the processor 402.

FIG. 5 is an illustration of one embodiment of a mobile device 500. Mobile devices 500 typically include a number of buttons 550 or keys 550 that the user may use in operating the mobile device 500. The mobile device 500 also includes a speaker 552 and a microphone 554. A display 556 is used to provide messages 558 to the user.

One example of a mobile device that may be used is a clamshell (flip phone) style, GSM mobile phone similar to the Sharp TM150 handset (not shown). It has a loudspeaker on the outside of cabinet, used for playing ringtones and music, and an earpiece and microphone on the inside that are accessible when the handset is opened, similar to the embodiment shown in FIG. 5. This example has buttons on the exterior of the handset that can be used to indicate whether a user wishes to screen an incoming call or not. There may also be a setting in the user interface, for example, “screen all calls” that would enable all calls to be screened if not answered. Finally, the user is subscribed to a network-based voicemail service. These aforementioned examples are set forth only by way of example and are in no way restrictions.

In the systems and methods herein, a mobile phone is equipped with a specific mechanism that enables the mobile phone owner to monitor callers as they leave a message on a network-based voicemail system. This enables the user to decide to answer a call midway through the message recording or leave it. The embodiments herein include two methods by which the handset is able to identify to the voicemail system that instead of presenting the voice mail control menu as happens today, it should go into message recording mode.

Further, in the embodiment of a flip-phone, call screening may be switched from the external loudspeaker of the handset to a more discrete earpiece by opening the flip.

The systems and methods herein include several features. A call screening mechanism that utilizes the call control features of a wireless handset and the operator's voicemail system so that messages are kept in one, unified voice mailbox that is able to identify to the voicemail service that instead of presenting the voice mail control menu when called, it should go into message recording mode. This may be accomplished by either (a) calling a voicemail number different to the standard one (i.e., one that is reserved for this purpose), or (b) calling the voicemail system anonymously and instructing it, via DTMF tones or otherwise, to record a message for the mailbox owner. An additional feature in one embodiment is that call screening can be switched from the external loudspeaker of the handset to a more discrete earpiece by opening the flip of a flip phone.

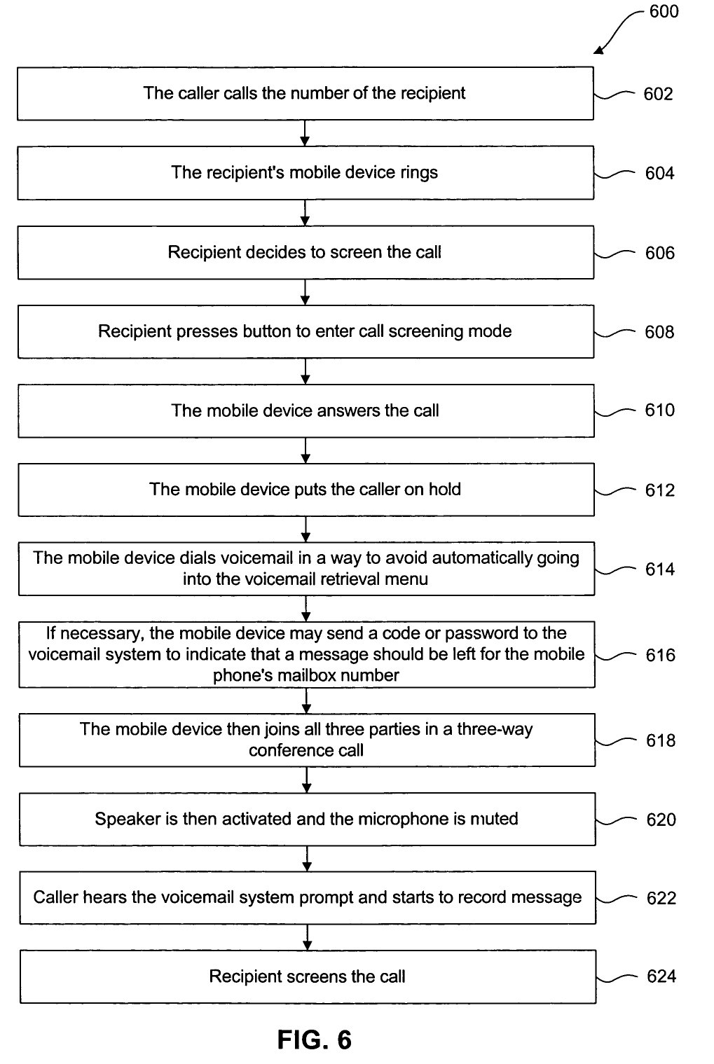

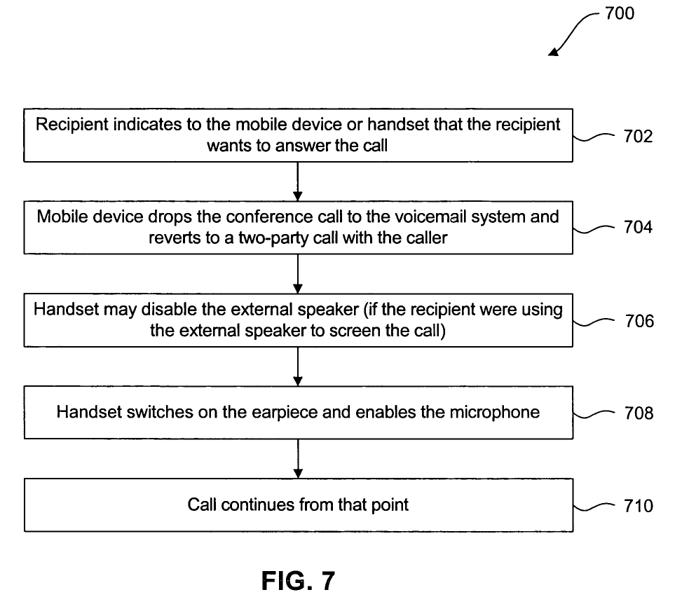

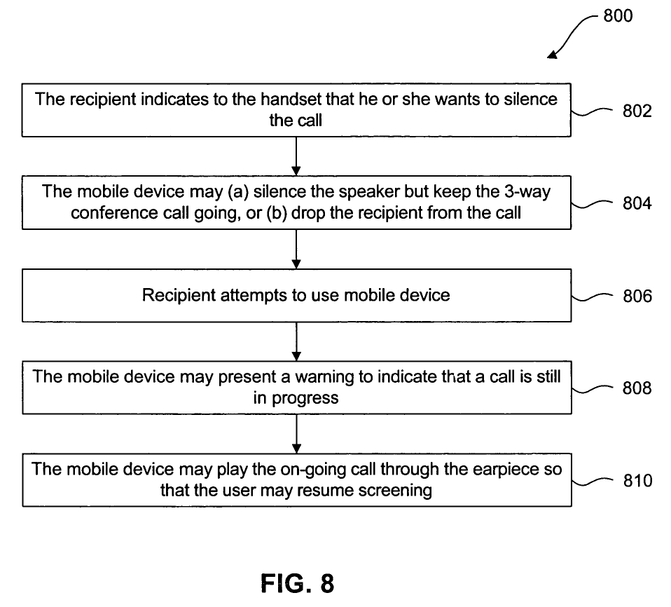

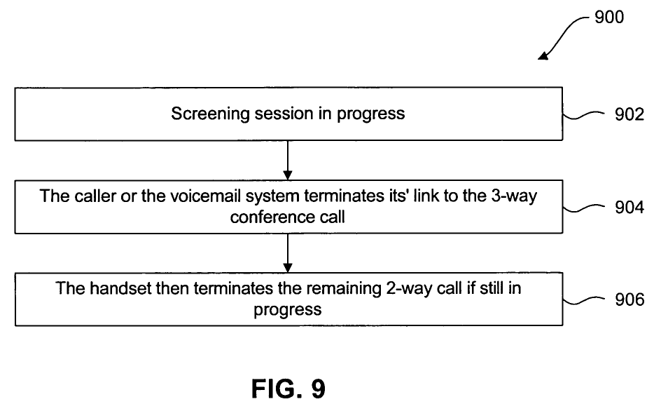

Through the remaining figures, the various stages of the systems and methods herein are illustrated. FIG. 6 illustrates the handling of an incoming call. FIG. 7 illustrates answering a call midway through a message recording. FIG. 8 illustrates ignoring the caller midway through the message recording. FIG. 9 illustrates finishing the call and disconnecting the call.

A flow diagram of an embodiment 600 of a method for handling an incoming call is shown in FIG. 6. The caller calls 602 the number of the recipient 102. The recipient's mobile device 102 rings 604. Once the recipient's mobile device 102 rings 604, the recipient may then decide 606 whether to screen the call or not. This may be as a result of looking at the incoming caller line ID that may show who is calling. The user may also decide whether to screen the call based on some other reason, such as the time of day, or any other circumstance.

In one embodiment the recipient may have preconfigured the mobile device 102 to screen the calls so that when a call comes in it is automatically screened. In such an embodiment the user does not have to make the decision about screening after the call comes in.

Referring again to FIG. 6, the recipient indicates 608 that the call is to be screened. If the recipient or user had not indicated that the call should be screened, the user may have just answered the call, rejected the call completely or send the call directly to voicemail. If the user wishes to screen the call, he or she may do so by pressing 608 a button on the mobile device 102. In one embodiment, the mobile device 102 may be a clamshell style device configured so that the recipient or user may press a “screen” button while the clamshell is closed. The screen button may also be configured to be used with a clamshell open, with different style mobile devices, through voice activation, etc.

Once the recipient has indicated 608 that the phone should enter screening mode, the mobile device 102 itself performs the following actions automatically. The mobile device answers 610 the call and puts 612 the caller on hold. Then the mobile device dials 614 the standard voicemail in a way so that the call does not automatically go into the voicemail retrieval menu. In certain embodiments the mobile device 102 answers 610 the call, puts 612 the caller on hold and dials 614 the voicemail number fast enough so that to the caller the process is transparent.

The actions of putting 612 the caller on hold and dialing 614 the voicemail may be combined in some network systems, in that by dialing a new number, the other call is automatically put on hold. Furthermore, for GSM systems, being put on hold is a network feature.

One way in which the mobile device 102 may dial 614 the standard voicemail in a way so that the call does not automatically go into the voicemail retrieval menu, is to dial the number anonymously (hide the caller ID). On a GSM system, an anonymous call can be made (Do not send Caller ID) by prefixing the dialed number with #31#. For example, #31#123 would call the voicemail system anonymously if the voicemail number were 123.

In another embodiment the mobile device 102 may dial 614 a special voicemail number so as to avoid the voicemail retrieval menu. A “special voicemail number” would be one that has been configured to identify the caller line ID of the mobile phone but not go into the owner's main menu system. Instead it will operate in exactly the same way as if the recipient had sent the caller to voicemail. For example, request that a message be left for the recipient. This embodiment is useful in that it is one of the more rapid methods of connecting to the voicemail system 106.

If necessary, the mobile device 102 may send 616 a code or password to the voicemail system 106 to indicate that a message should be left for the mobile phone's mailbox number (which is the handset's own number). For example, if a call is made to a voicemail system 106 and it cannot identify the caller via caller line ID, it will often be in a mode where it can be instructed to record a message for any mailbox serviced by the system. For example, with the T-Mobile U.S. system, sending # followed by the 10 digit telephone number (mailbox number) will play the voicemail message for that mailbox and start to record the caller's message for that number. This overcomes the problem of having to have a separate voicemail number for call screening.

The mobile device 102 then joins 618 all three parties. The three parties being joined 618 in a three-way conference call are the caller 110, the user's or recipient's handset 102 and the voicemail system 106. The speaker is then activated 620 and the microphone is muted so the user can hear everything on the call without being heard.

The foregoing actions should occur quickly as the system is digital in nature and so should not be obvious to the caller that it is happening. Some currently available systems require that a message be played to the caller such as “please wait while we connect your call”. The systems and methods herein do not require that step. Avoiding such a step is advantageous because that message could indicate to a caller that the message will be screened.

After the above steps, the caller 110 will hear 622 the voicemail system prompt and start to record their message. At the same time, the recipient 102 will be able to listen 624 in to the message as it is being recorded. This enables the user to screen 624 the call.

FIG. 7 is a flow diagram of an embodiment 700 of a method to answer the call that is being screened midway through the message recording. If the recipient 102 wishes to answer the call during the message recording, he or she may do so by doing the following actions.

The recipient may indicate 702 to the mobile device 102 or handset that the recipient wants to answer the call. This may be done in a variety of ways, for example the recipient may simply press a button. In addition, the recipient may simply open a clamshell style phone. Typically when this opening action occurs with a clamshell style phone the external loudspeaker switches off and the internal earpiece is used instead. The phone then provides the user with a choice to answer the call or not. This enables calls to be screened more privately than by using the loudspeaker.

Upon receiving the indication 702 that the recipient wishes to answer the call, the handset drops 704 the conference call to the voicemail system 106 and reverts to a two-party call with the caller 110. If the recipient 102 were using the external speaker to screen the call, the handset may disable 706 the external speaker, switch 708 on the earpiece and enable the microphone. The call may then continue 710 from that point.

FIG. 8 is a flow diagram illustrating an embodiment 800 of a method for the recipient 102 to ignore the caller midway through the message recording. If the user does not wish to answer the call or continue to listen to the caller during the message recording, the user may perform the actions shown in FIG. 8. The recipient may indicate 802 to the handset 102 that he or she wants to silence the call. In one embodiment, the same button may be used to indicate that the call should be silenced as was used to indicate that the call should be screened. However, other methods may be used. For example a long-push of the button may be used, or a different button, etc.

Upon receiving the indication 802 that the call is to be silenced, the mobile device 102 or handset silences 804a the speaker but keeps the 3-way conference call going or the recipient may be dropped 804b from the call. GSM systems require the handset to keep the call going as it is the initiator of the conference call and when it drops the call, all parties are disconnected. In that situation the handset 102 would need to silence 804a the speaker but keep the 3-way conference call going. On a different network system it may be possible for the handset 102 to leave the 3-way conference call but allow the caller and the voicemail system to stay connected in a 2-way call. In that situation the recipient 102 may be dropped 804b from the call.

The remaining steps 806-810 may be performed in the situation where the 3-way call was continued after the recipient indicated 802 that he or she wanted to silence the call. The steps 806-810 typically would not be used in a situation where only a 2-way call was in progress.

If the user subsequently attempts 806 to use (e.g., opens) the phone to make a call and the 3-way call is still active, the handset 102 may present 808 a warning on the screen or play a sound or message to indicate that a call is still in progress. Additionally, the mobile device 102 may play 810 the on-going call through the earpiece so the user can listen to it and decide if they wish to cut it off. The handset 102 may also provide the user with a way to interrupt the message recording and answer the call, as discussed in relation to FIG. 7.

Referring now to FIG. 9, a flow diagram 900 is shown illustrating the completion of the call. A screening session is in progress 902. At the end of the call when in screening mode, the caller or the voicemail system has terminated 904 their link to the 3-way conference call. The handset 102 then terminates 906 the remaining 2-way call if still in progress.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A mobile telecommunications device that is configured for use in a wireless communication system, comprising:
a processor;
memory in electronic communication with the processor; and
instructions stored in the memory, the instructions being executable to implement a method for call screening comprising:
receiving an incoming call from a caller;
answering the incoming call;
putting the incoming call on hold;
dialing into voicemail such that the voicemail call does not automatically go into the voicemail retrieval menu; and
joining the incoming call and the voicemail call into a three-way conference call such that a user of the mobile telecommunications device is able to screen the incoming call.

2. The mobile telecommunications device of claim 1, wherein dialing into voicemail such that the voicemail call does not automatically go into the voicemail retrieval menu comprises dialing a voicemail number anonymously.

3. The mobile telecommunications device of claim 1, wherein dialing into voicemail such that the voicemail call does not automatically go into the voicemail retrieval menu comprises dialing a special voicemail number so as to avoid the voicemail retrieval menu.

4. The mobile telecommunications device of claim 3, wherein the special voicemail number is configured to identify caller line ID of the mobile telecommunications device's voicemail call but not go into the voicemail retrieval menu.

5. The mobile telecommunications device of claim 1, wherein dialing into voicemail such that the voicemail call does not automatically go into the voicemail retrieval menu comprises sending a code or password to the voicemail to indicate that a message should be left for the mobile telecommunications device's mailbox number.

6. The mobile telecommunications device of claim 1, wherein the method for call screening further comprises:
activating a speaker on the mobile telecommunications device; and
muting a microphone on the mobile telecommunications device.

7. The mobile telecommunications device of claim 1, wherein the method for call screening further comprises:
receiving user input indicating that the user wishes to answer the incoming call that is being screened; and
dropping the voicemail call so that only a two-party call is active.

8. The mobile telecommunications device of claim 7, wherein the method for call screening further comprises enabling a microphone on the mobile telecommunications device.

9. The mobile telecommunications device of claim 1, wherein the method for call screening further comprises:
receiving user input indicating that the user wishes to silence the incoming call that is being screened; and
silencing a speaker on the mobile telecommunications device.

10. The mobile telecommunications device of claim 1, wherein the method for call screening further comprises:
receiving user input indicating that the user wishes to silence the incoming call that is being screened; and
dropping the user so that only a two-party call is active and is the incoming call to the voicemail.

11. The mobile telecommunications device of claim 9, wherein the method for call screening further comprises:
receiving user input comprising an attempt by the user to use the mobile telecommunications device; and
presenting a warning to the user that indicates call screening is still in progress.

12. The mobile telecommunications device of claim 1, wherein the method for call screening further comprises receiving user input indicating that the incoming call is to be screened.

13. In a mobile telecommunications device, a method for call screening comprising:
receiving an incoming call from a caller;
answering the incoming call;
putting the incoming call on hold;
dialing into voicemail such that the voicemail call does not automatically go into the voicemail retrieval menu; and
joining the incoming call and the voicemail call into a three-way conference call such that a user of the mobile telecommunications device is able to screen the incoming call.

14. The method of claim 13, wherein dialing into voicemail such that the voicemail call does not automatically go into the voicemail retrieval menu comprises dialing a voicemail number anonymously.

15. The method of claim 13, wherein dialing into voicemail such that the voicemail call does not automatically go into the voicemail retrieval menu comprises dialing a special voicemail number so as to avoid the voicemail retrieval menu.

16. The method of claim 13, wherein the special voicemail number is configured to identify caller line ID of the mobile telecommunications device's voicemail call but not go into the voicemail retrieval menu.

17. The method of claim 13, further comprising:
activating a speaker on the mobile telecommunications device; and
muting a microphone on the mobile telecommunications device.

18. The method of claim 17, further comprising:
receiving user input indicating that the user wishes to answer the incoming call that is being screened; and
dropping the voicemail call so that only a two-party call is active.

19. The method of claim 18, further comprising enabling a microphone on the mobile telecommunications device.

20. The method of claim 17, further comprising:
receiving user input indicating that the user wishes to silence the incoming call that is being screened; and
silencing a speaker on the mobile telecommunications device.

21. The method device of claim 20, further comprising:
receiving user input comprising an attempt by the user to use the mobile telecommunications device; and
presenting a warning to the user that indicates call screening is still in progress.

22. The method of claim 13, further comprising receiving user input indicating that the incoming call is to be screened.
